(19) United States
(12) Patent Application Publication
(10) Pub. No.: US 2003/0052051 A1
(43) Pub. Date: Mar. 20, 2003

(54) Fluid supplying manifold having multiple ports

(76) Inventors: Young Sik Nam, Suwon City (KR); Soon Tae Kim, Uiwang City (KR)

Correspondence Address: CHA & REITER, 411 Hackensack Ave, 9th Floor, Hackensack, NJ, 07601, US

(21) Appl. No.: 10/191,616

(22) Filed: Jul. 9, 2002

(30) Foreign Application Priority Data
Sep. 17, 2001 (KR) 2001-57299

(51) Int. Cl. B01D 35/157

(52) U.S. Cl. 210/418

(57) ABSTRACT

Disclosed is a fluid supplying manifold having multiple ports. The manifold has an inlet device for fluid inflow and an outlet device for fluid outflow. The inlet and outlet devices include first and second valve assemblies, respectively. A solenoid of the first valve assembly is turn on/off in response to a control signal from a controller. The outlet device is provided with a chamber. The second valve assembly includes an electromagnetic valve, and a sealing block is disposed in the chamber. The sealing block is defined with a pair of guide holes which extend in a longitudinal direction and a T-shaped flow passage. A flow path switchover member functions to divert fluid flowing through the chamber into a first or second outlet port. The flow path switchover member includes a hollow cylindrical body, a pair of bars, a pair of holes and a stopcock. A spring is placed between the flow path switchover member and a bottom surface of the chamber. When a solenoid of the second valve assembly is in an OFF state, the spring supports the sealing block and the flow path switchover member to block the flow passage. When the solenoid is in an ON state, the flow passage is opened.

### BACKGROUND OF THE INVENTION

1. Field of the Invention

The present invention relates to a manifold to which a replaceable fluid filter cartridge constituting a part of a water purification system is coupled, and more particularly, the present invention relates to a manifold which provides a jointing structure for allowing fluid supplying and discharging pipes to be easily jointed with and disjointed from inlet and outlet ports of inlet and outlet devices of the manifold, and which prevents fluid leakage from fluid supply lines.

2. Description of the Related Art

With the development of living appliances used at home or in offices, etc., demand for water purification and filtration systems to be used in a state wherein they are coupled to the appliances has been gradually increased. A water purification or filtration device serving as one main component element of such water purification and filtration systems typically adopts a replaceable filter cartridge. In this regard, it is the norm that filter cartridges are formed each to have a single or unitary port having multiple flow channels therein, and this type of filter cartridges are disclosed in U.S. Pat. Nos. 4,915,831, 5,336,406 and 5,354,464.

A connecting device or manifold serving as another main component element of the water purification and filtration system functions to receive and transfer fluid such as water to the filter cartridge and direct filtered fluid to desired places inside the appliance. Each of the connecting devices or manifolds such as disclosed in U.S. Pat. Nos. 4,915,831, 5,336,406 and 5,753,107 is provided with a single inlet port and a single outlet port, and the connecting device or manifold such as disclosed in U.S. Pat. No. 5,354,464 is provided with multiple ports.

Meanwhile, it is necessary to periodically change the filter cartridge used in the water purification and filtration system. In this connection, a problem is caused in that leakage may occur in water supply lines upon changing the filter cartridge. In order to prevent leakage from water supply lines upon changing a filter cartridge, as described in U.S. Pat. No. 5,753,107, a flow control valving must be provided to a manifold or the filter cartridge. As the case may be, the filter cartridge can be inadvertently decoupled from a connecting device to cause water leakage. Solutions to cope with this problem are disclosed in U.S. Pat. Nos. 4,915,831 and 5,336,406.

Due to the fact that the conventional water purification and filtration system adopts a configuration that, by rotating the filter cartridge in one direction relative to the connecting device, they are coupled to each other, and by rotating the filter cartridge in the other direction, they are decoupled from each other, coupling and decoupling of the filter cartridge and connecting device to and from each other can be easily effected. In order to ensure that water is supplied from a water supply source such as waterworks or a water tank to the connecting device and flows through the filter cartridge, and filtered water is directed again through the connecting device to a desired place (for example, an ice making section of a refrigerator), a conduit such as a pipe should be provided to join the connecting device and the water supply source with each other. In the conventional art, disadvantages are caused in that, since a screwed type pipe fitting structure is adopted in which pipes are threadedly joined to ports of the connecting device, it is cumbersome and time-consuming to connect, using pipes, an inlet port of the connecting device with the water supply source and an outlet port of the connecting device with the desired place. Because the connecting device and the pipes are joined with each other in this way, when it is necessary to change the pipes due to aging, damage, etc., laborious work must be carried out.

Moreover, in the conventional connecting device, it is considered as an essential point to define inlet and outlet passages for receiving water from the water supply source, transferring water to the filter cartridge and directing the filtered water to the desired place. Therefore, it is difficult to install on the manifold itself a fluid-flow shutoff valve for preventing water leakage upon changing the filter cartridge. Also, even in the case that the fluid-flow shutoff valve is installed on the manifold, the connecting device and the filter cartridge must be designed in such a way as to structurally interact with each other.

Further, in the case that the conventional water purification and filtration system is used in an ice making apparatus, when an amount of fluid flowing through fluid supply lines is decreased due to interruption of fluid supply as it occurs where the filter cartridge is changed with new one, unless fluid flow to the ice making apparatus is completely shut off, defects may result from freezing of water. That is to say, when the filter cartridge is decoupled from the connecting device and thereby fluid supply from the water supply source is interrupted, if fluid flow to the ice making apparatus is not completely shut off and even a small amount of water continuously flows into the ice making apparatus, the fluid supply lines are likely to be frozen, which adversely influences surrounding arrangements.

### SUMMARY OF THE INVENTION

Accordingly, the present invention has been made in an effort to solve the problems occurring in the related art, and an object of the present invention is to provide a pipe connecting structure which allows fluid supplying and discharging pipes for supplying and discharging fluid to and from a manifold, to be easily jointed with and disjointed from inlet and outlet ports of the manifold.

Another object of the present invention is to provide a manifold of which inlet and outlet devices are designed to have chambers to be connected with valve devices, thereby performing a function of a multi-port connecting device.

Still object of the present invention is to provide a flow control unit which is arranged in an outlet port of an outlet device of a manifold to control a flow rate of fluid discharged from the outlet device through the outlet port, in response to a fluid amount variation.

Yet still another object of the present invention is to provide a manifold which, in the case of being used along with an ice making apparatus, completely shuts off fluid flow to the ice making apparatus when fluid supply is interrupted as it occurs where a filter cartridge is changed with new one, thereby preventing conduits and surrounding arrangements from being damaged due to freezing of water.

The above-described objects and other advantages are achieved by a manifold according to the present invention. The manifold has an inlet device for fluid inflow and an outlet device for fluid outflow. The inlet and outlet devices include first and second valve assemblies, respectively.

The first valve assembly of the inlet device includes an electromagnetic valve which controls fluid flow in response to an electric signal. A valve body constitutes a part of the first valve assembly in a manner such that a dome-shaped protuberance is formed in a cavity of an inlet port and a communication aperture for rendering fluid communication is defined through the dome-shaped protuberance. A solenoid of the first valve assembly is turn on/off in response to a control signal from a controller.

The outlet device is provided with a chamber. The second valve assembly is provided in association with the chamber. The second valve assembly includes an electromagnetic valve, and a sealing block is disposed in the chamber. The sealing block generally has a drum-shaped configuration, and an annular recess is defined on a circumferential outer surface of the sealing block. The sealing block is defined with a pair of guide holes which extend in a longitudinal direction and a T-shaped flow passage. A flow path switchover member functions to divert fluid flowing through the chamber into a first or second outlet port. The flow path switchover member includes a hollow cylindrical body, a pair of bars, a pair of holes and a stopcock. A spring is placed between the flow path switchover member and a bottom surface of the chamber. When a solenoid of the second valve assembly is in an OFF state, the spring supports the sealing block and the flow path switchover member against elastic force of another spring which is disposed in the solenoid.

All or at least one of outlet ports is provided with flow control means which includes a flow control unit. The flow control unit is made of a soft material and has a sinking surface, an opposite flat surface and a flow control hole defined through a center portion thereof.

As a consequence, when fluid is discharged from the outlet port of the outlet device, the fluid flows through the flow control hole of the flow control unit. At this time, because a fluid pressure is applied to the flow control unit, the sinking surface and the opposite flat surface are displaced in a manner such that they are reversed in their surface contours. Due to the displacement, a diameter of one end of the flow control hole, which one end faces an outlet aperture, is slightly increased, and a diameter of the other end of the flow control hole, which other end is farthest from the outlet aperture, is slightly decreased, whereby fluid flow control can be executed in a precise manner.

### BRIEF DESCRIPTION OF THE DRAWINGS

The above objects, and other features and advantages of the present invention will become more apparent after a reading of the following detailed description when taken in conjunction with the drawings, in which:

FIG. 1 is a cross-sectional view illustrating an entire construction of a manifold in accordance with an embodiment of the present invention;

FIG. 2 is an exploded perspective view illustrating a sealing block and a flow path switchover member which constitute a second valve assembly of the manifold according to the present invention;

FIGS. 3A and 3B are cross-sectional views illustrating states wherein fluid flows through an inlet port into a housing and is discharged through respective outlet ports from the housing in the manifold according to the present invention;

FIG. 4 is a partial enlarged cross-sectional view illustrating flow control means provided in one of the outlet ports; and

FIGS. 5A and 5B are cross-sectional views illustrating a structure for connecting a pipe to the inlet port or outlet port of the manifold according to the present invention.

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

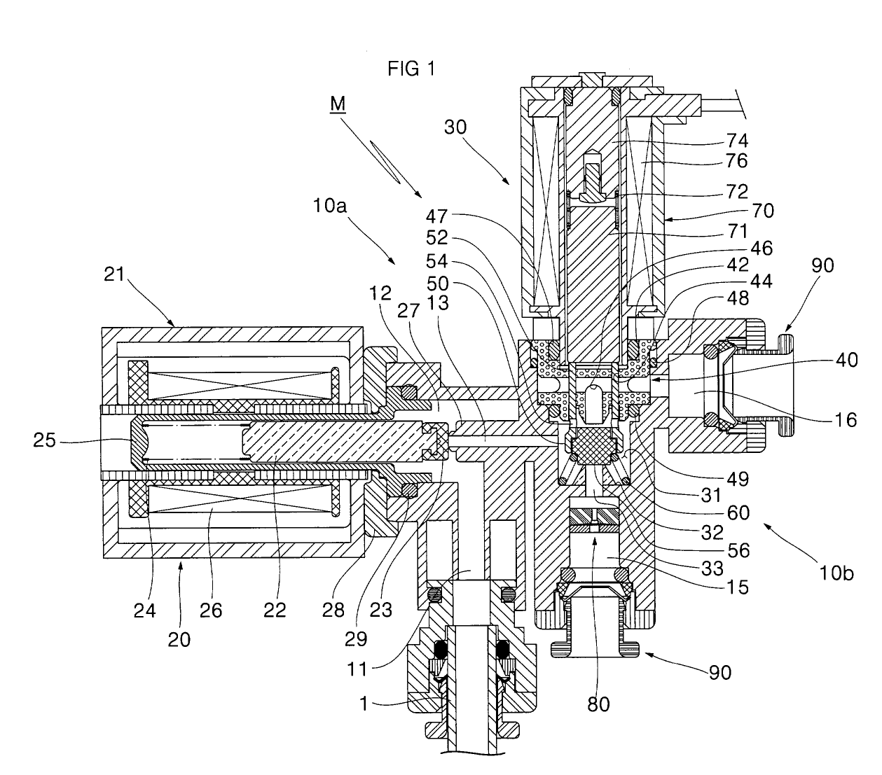

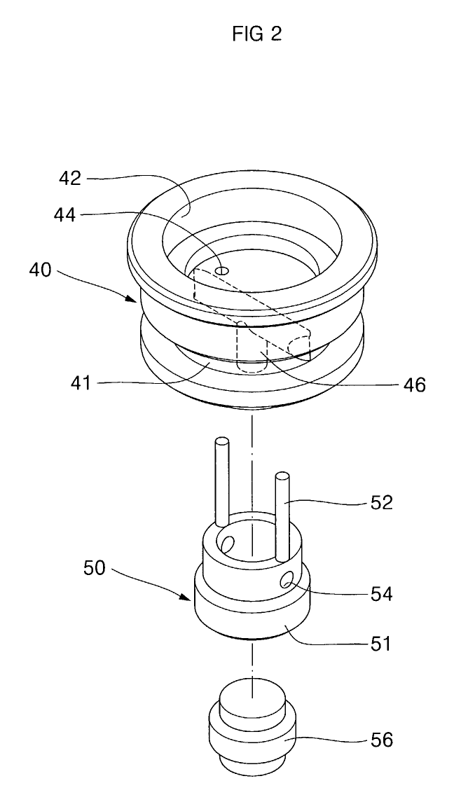

Referring to FIGS. 1 and 2, a manifold M in accordance with an embodiment of the present invention includes an inlet device 10a and an outlet device 10b. The inlet device 10a is connected to a fluid supply pipe 1 such as waterworks, to receive fluid, that is, water. The outlet device 10b functions to direct fluid received in the inlet device 10a to a desired place. The inlet device 10a receives fluid through an inlet port 11 which is connected to the fluid supply pipe 1. The inlet device 10a is defined with a cavity 12 for temporarily storing fluid received through the inlet port 11. A first valve assembly 20 is installed in the cavity 12.

The first valve assembly 20 includes an electromagnetic valve. A body of the inlet device 10a serves by itself as a valve body of the first valve assembly 20. The first valve assembly 20 has a solenoid 21 and a movable member 22. The movable member 22 is provided with a valve head 23. The movable member 22 is arranged in a casing 25, and a spring 24 is intervened between an inner bottom surface of the housing 25 and the movable member 22 to close a communication aperture 13 when the solenoid 21 is in an OFF state. A coil 26 is placed around the housing 25. The coil 26 can generate electromagnetic force for operating the movable member 22, in response to application of an electric signal from a controller (not shown).

The body of the inlet device 10a is formed with a dome-shaped protuberance. The protuberance serves as a valve seat 27 for the first valve assembly 20. A sealing element 28 and an O-ring 29 are provided to prevent water leakage. The communication aperture 13 is defined through the valve seat 27 to allow fluid to flow from the inlet device 10a to the outlet device 10b under the control of the first valve assembly 20.

The outlet device 10b is integrally formed with the inlet device 10a, and has first and second outlet ports 15 and 16 for discharging fluid received from the inlet device 10a. Pipes are connected to the respective outlet ports 15 and 16 by pipe jointing assemblies 90, as will be described later in detail. A chamber 31 is defined in the outlet device 10b. A second valve assembly 30 is provided in the chamber 31. Therefore, the outlet device 10b serves as a valve box or a valve body in relation to the second valve assembly 30 and the first and second outlet ports 15 and 16.

The chamber 31 is defined in one end of the outlet device 10b serving as the valve body in a manner such that the chamber 31 has a plurality of stepped shoulders. The valve device disposed in the chamber 31 performs a function of a multi-port connecting device. The chamber 31 is communicated with the communication aperture 13 of the inlet device 10a. A tapered projection 32 is formed on a bottom surface of the chamber 31 to serve as a valve seat, and an outlet aperture 33 is defined through the tapered projection 32.

A sealing block 40 which generally has a drum-shaped configuration is placed in the chamber 31. The sealing block 40 is defined, at a middle portion and on a circumferential outer surface thereof, with an annular recess 41. Also, the sealing block 40 is defined, on an upper surface thereof, with a receiving groove 42. A pair of guide holes 44 which extend in a longitudinal direction are defined through a bottom of the receiving groove 42. A T-shaped flow passage 46 is defined in the sealing block 40 below the receiving groove 42 and adjacent to the guide holes 44. O-rings 47, 48 and 49 are provided to prevent water leakage.

The second valve assembly 30 includes a flow path switchover member 50. The flow path switchover member 50 has a hollow cylindrical body 51, a pair of bars 52 which extend upward from an upper end of the hollow cylindrical body 51, and a pair of holes 54 which are defined through opposite sides of the hollow cylindrical body 51. When the flow path switchover member 50 is coupled with the sealing block 40, the bars 52 of the flow path switchover member 50 are respectively inserted through the guide holes 44 of the sealing block 40 in a manner such that the bars 52 can be slidingly moved upward and downward in the guide holes 44. In a state wherein the flow path switchover member 50 and the sealing block 40 are coupled with each other, the holes 54 of the flow path switchover member 50 are communicated with the chamber 31.

A stopcock 56 having a cross-shaped sectional configuration is fitted into a lower end of the flow path switchover member 50. A height of the stopcock 56 is determined in a manner such that the stopcock 56 does not block the holes 54 upon being fitted into the flow path switchover member 50. The flow path switchover member 50 into which the stopcock 56 is fitted is supported by a spring 60. Here, elastic force of the spring 60 is set to be larger than that of a spring 72 arranged in a solenoid 70, in a manner such that, when a magnetic field is not created in the solenoid 70, the flow path switchover member 50 is not moved downward by being pressed by a movable member 71.

The second valve assembly 30 includes an electromagnetic valve. The solenoid 70, that is, an actuator serving as the electromagnetic valve has the movable member 71, a fixed member 74, and the spring 72 which is interposed between the movable and fixed members 71 and 74. A coil 76 provided to the solenoid 70 creates a magnetic field in response to application of an electric signal to move the movable member 71.

A pair of pipe jointing assemblies 90 are provided to the outlet device 10b in which the second valve assembly 30 is disposed, as will be descried later in detail, in a manner such that pipes are connected to the first and second outlet ports 15 and 16 by virtue of the pipe jointing assemblies 90. Accordingly, fluid can flow into the inlet device 10a of the manifold M and thereafter be discharged through one of the first and second outlet ports 15 and 16 depending upon an operation of the second valve assembly 30.

Describing operations of the manifold M according to the present invention, constructed as mentioned above, with reference to FIGS. 1 through 3, as an electric signal is applied from the controller, the solenoid 21 of the first valve assembly 20 is switched to an ON state, and thereby, a magnetic field is created in the coil 26, whereby the movable member 22 is moved inward of the casing 25 by electromagnetic force. Thus, as the movable member 22 is moved against elastic force of the spring 24, the communication aperture 13 is opened. If the communication aperture 13 is opened, fluid flows through the inlet port 11, and then, after passing through the cavity 12, is introduced into the chamber 31 of the outlet device 10b through the communication aperture 13.

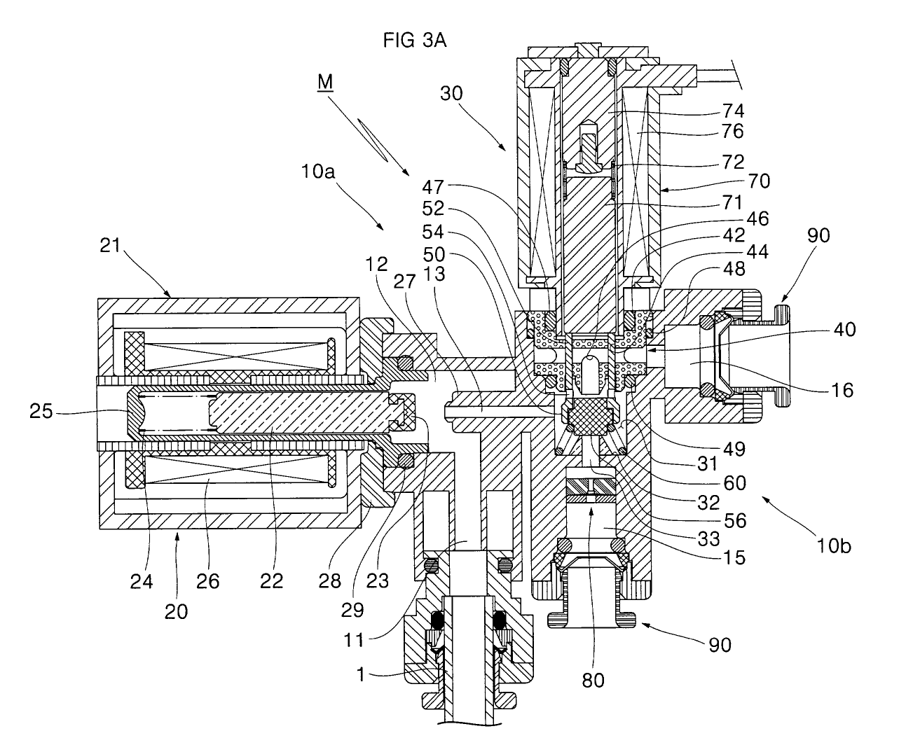

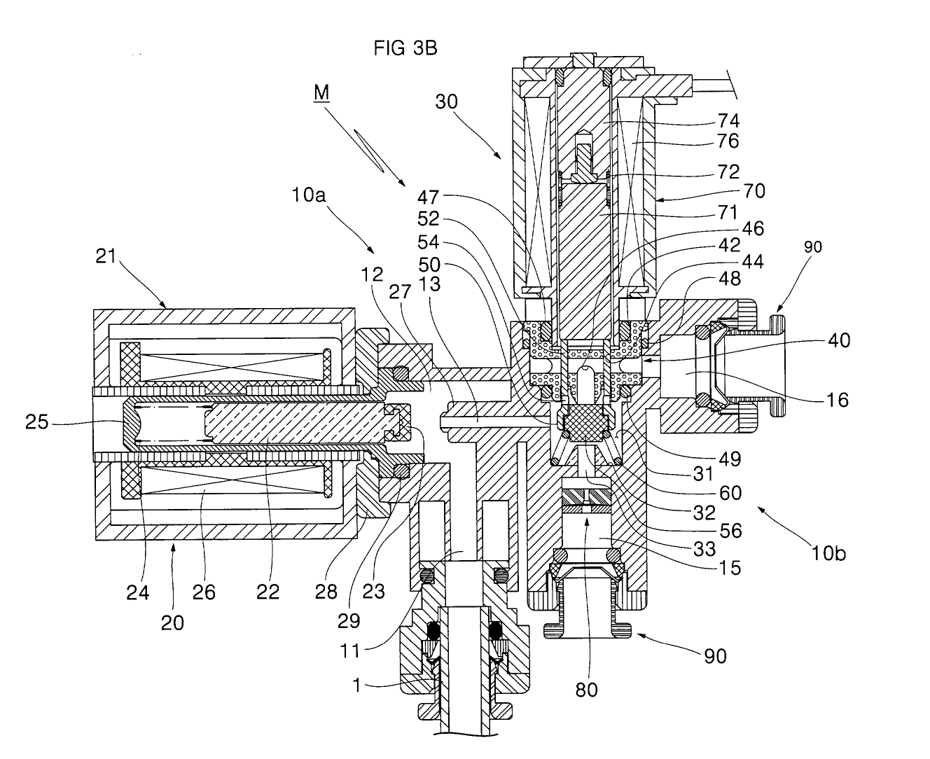

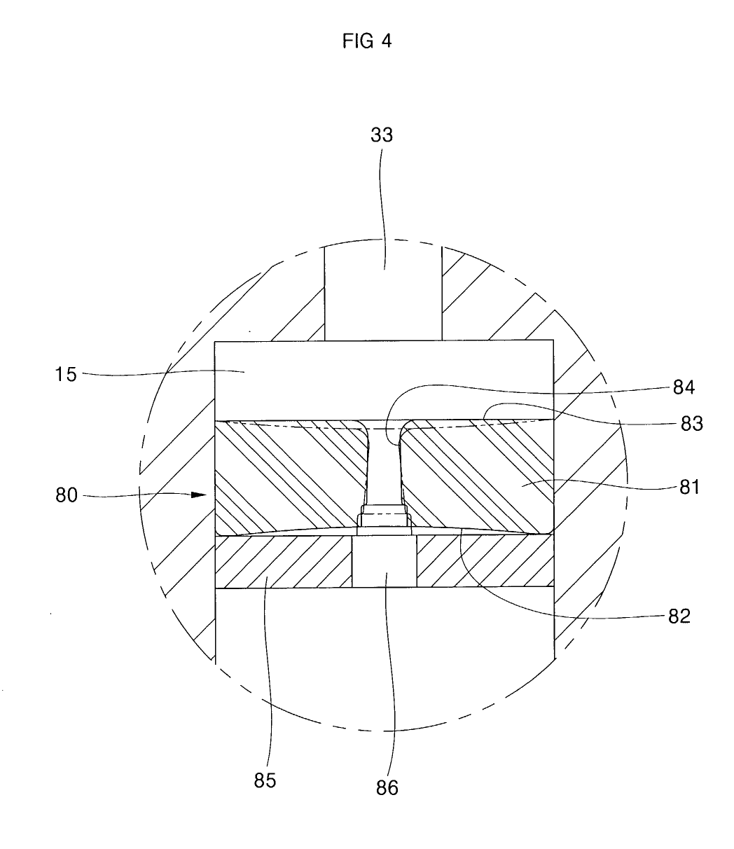

At this time, as can be readily seen from FIG. 3A, since the solenoid 70 of the second valve assembly 30 is in an ON state, the movable member 71 is moved downward to press the bars 52 of the flow path switchover member 50. By this fact, the flow path switchover member 50 is moved downward while overcoming elastic force of the spring 60. Therefore, the stopcock 56 of the flow path switchover member 50 closes the outlet aperture 33 of the chamber 31. If the outlet aperture 33 of the chamber 31 is closed, fluid introduced into the chamber 31 through the communication aperture 13 is discharged into the second outlet port 16 through the holes 54 of the flow path switchover member 50 and the T-shaped flow passage 46 of the sealing block 40.

On the other hand, when it is necessary to discharge fluid through the first outlet port 15 of the outlet device 10b, as the solenoid 70 is turned off, since elastic force of the spring 60 supporting the flow path switchover member 50 is larger than that of the spring 72 arranged between the movable and fixed members 71 and 74 of the solenoid 70, the movable member 71 is moved upward by way of the bars 52 of the flow path switchover member 50. Accordingly, an upper surface of the stopcock 56 of the flow path switchover member 50 closes an entrance to the T-shaped flow passage 46 of the sealing block 40 and opens the outlet passage 33 of the chamber 31. Thus, fluid is discharged through the first outlet port 15 of the outlet device 10b.

Referring to FIG. 3, flow control means 80 can be provided to the first and second outlet ports 15 and 16 of the outlet device 14b. In this preferred embodiment of the present invention, the flow control means 80 is provided to the first outlet port 15. The flow control means 80 has a disc-shaped flow control unit 81. The flow control unit 81 is made of a material having a predetermined flexibility in a manner such that the flow control unit 81 can be displaced by a pressure change of fluid flowing through the first outlet port 15.

The flow control unit 81 has a gradually curved and sinking surface 82 which is distant from the outlet aperture 33, and a flat surface 83 which is opposite to the gradually curved and sinking surface 82. A flow control hole 84 is defined through a center portion of the flow control unit 81. A retainer 85 is fitted into the first outlet port 15 to prevent release of the flow control unit 81. The retainer 85 is defined with a center hole 86 which is aligned and communicated with the flow control hole 84.

When fluid does not flow through the first outlet port 15 of the outlet device 10b, the flow control unit 81 is maintained in an initially installed state. That is to say, the gradually curved and sinking surface 82 is maintained in a curved and sinking state, and the opposite flat surface 83 is maintained in a flattened state. On the other hand, if fluid starts to flow through the first outlet port 15, as a fluid pressure is applied to the flat surface 83 of the flow control unit 81 while fluid flows through the flow control hole 84, the gradually curved and sinking surface 82 of the flow control unit 81 made of a flexible material is moved forward to be flattened and then comes into surface contact with the retainer 85. Further, as the flat surface 83 opposite to the sinking surface 82 is gradually depressed, the flow control unit 81 experiences displacement.

The flow control hole 84 is influenced by the displacement in which the gradually curved and sinking surface 82 and opposite flat surface 83 of the flow control unit 81 are reversed in their surface contours. Hence, by the fact that the sinking surface 82 is transformed from a curved surface to a flat surface by fluid flow through the flow control hole 84, a diameter of one end of the flow control hole 84, which one end is distant from the outlet aperture 33, is slightly increased. On the contrary, a diameter of the other end of the flow control hole 84, which other end faces the outlet aperture 33, is slightly decreased. As a result, the flow control hole 84 generally has a funnel-shaped configuration. In the case that fluid does not flow through the first outlet port 15, the flow control unit 81 is returned to its original state. In this way, fluid flow control can be executed by the flow control means 80 in the first outlet port 15 in correspondence to fluid flow and fluid flow interruption.

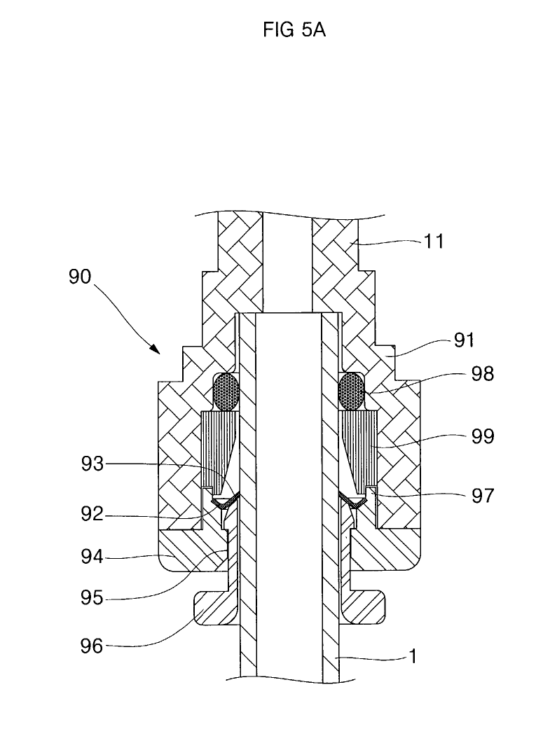

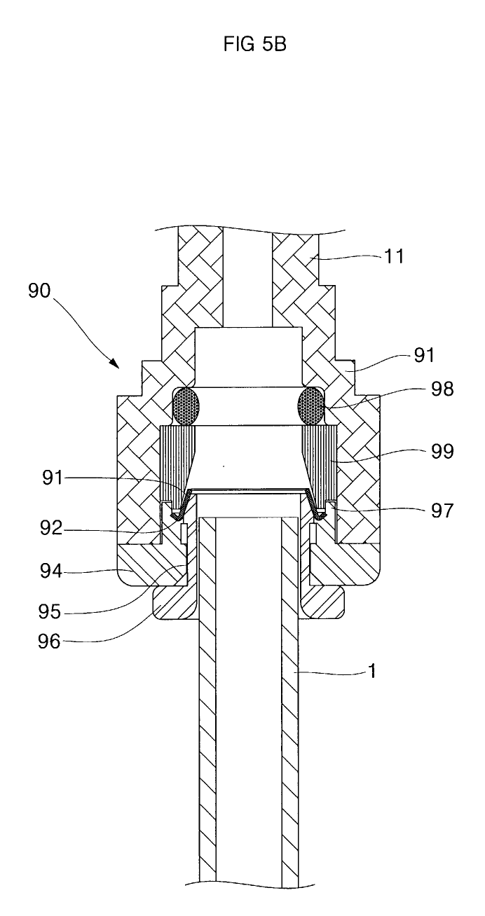

FIG. 5A illustrates a state wherein two pipes are connected with each other, and FIG. 5B illustrates another state wherein two pipes are disconnected from each other. Describing, for example, the case that the inlet port 11 and the fluid supply pipe 1 are connected with each other, a coupling end portion 91 of the inlet port 11 has a plurality of stepped surfaces on which various component elements are disposed. The pipe jointing assembly 90 includes a pipe fastening member 92. The pipe fastening member 92 has an annular frame portion and a plurality of elastic supporting fragments 93 integrally extending from the annular frame portion. Also, the pipe jointing assembly 90 is provided with a cylindrical fixing cap 94. The cylindrical fixing cap 94 has a head and a shoulder 97 for holding the pipe fastening member 92. The fixing cap 94 is defined with a center hole 95 through which the inlet port 11 can be inserted. The pipe jointing assembly 90 further includes an unlocking member 96 for allowing the inlet port 11 and the water supply pipe 1 to be decoupled from each other, and a holder 99 which has an inclined surface for keeping the pipe fastening member 92 from being released upon decoupling the inlet port 11 and the water supply pipe 1 from each other. Further, an O-ring 98 is provided to prevent water leakage.

When the inlet port 11 and the water supply pipe 1 are connected with each other, as shown in FIG. 5A, by pushing the water supply pipe 1 into the inlet port 11, the water supply pipe 1 is inserted into the inlet port 11 while overcoming force of the elastic supporting fragments 93 of the pipe fastening member 92 until a free end of the water supply pipe 1 is brought into contact with an innermost stepped surface which is formed in the coupling end portion 91 of the inlet port 11. Then, as the elastic supporting fragments 93 of the pipe fastening member 92 radially apply force to the water supply pipe 1, the water supply pipe 1 is reliably held coupled to the inlet port 11.

When the inlet port 11 and the water supply pipe 1 are disconnected from each other, as shown in FIG. 5B, by pushing the unlocking member 96 into the coupling end portion 91 of the inlet port 11, a free end of the unlocking member 96 separates the elastic supporting fragments 93 from the water supply pipe 1, whereby it is possible to easily decouple the water supply pipe 1 from the inlet port 11. At this time, due to the fact that the elastic supporting fragments 93 of the pipe fastening member 92 are stably held by the inclined surface of the holder 99, the pipe fastening member 92 is kept from being released from the shoulder 97 of the fixing cap 94.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A manifold adapted for supplying fluid to a fluid treatment device and discharging treated fluid to a desired place, the manifold comprising:
an inlet device including (a) an inlet port to be connected with an inlet conduit, and (b) a first valve assembly having a solenoid which possesses a movable member and a coil, a valve head which is joined to the movable member, and a communication aperture which is opened and closed by the valve head of the movable member;
a chamber communicated with the communication aperture and having first and second outlet ports; and
a second valve assembly disposed in the chamber and having a sealing block, a flow path switchover member, a solenoid and a spring, the sealing block having a flow passage which is communicated with the first outlet port and a pair of guide holes, the flow path switchover member having a body, a pair of bars which extend upward from the body and are slidably inserted through the guide holes of the sealing block and a pair of holes which are defined through opposite sides of the body and communicated with the chamber, wherein, when the solenoid of the second valve assembly is not operated, the spring supports the flow path switchover member to block the flow passage communicated with the first outlet port, and when the solenoid is operated, the solenoid presses downward the bars of the flow path switchover member and thereby moves the flow path switchover member against elastic force of the spring to close the second outlet port, whereby the solenoid selectively opens and closes the second outlet port and the flow passage communicated with the first outlet port to control fluid flow through the first and second outlet ports.

2. The manifold as set forth in claim 1, wherein the body of the flow path switchover member possesses a hollow cylindrical configuration, and further has a stopcock which is fitted into the body, to open and close the flow passage and the second outlet port when the flow path switchover member is moved by the solenoid and the spring.
